(19) United States
(12) Patent Application Publication
(10) Pub. No.: US 2006/0265201 A1
(43) Pub. Date: Nov. 23, 2006

(54) Method of improving workflows for a print shop

(76) Inventor: Nathaniel G. Martin, Rochester, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/120,568

(22) Filed: May 3, 2005

(51) Int. Cl. G06G 7/48; G06F 19/00

(52) U.S. Cl. 703/6; 703/2; 700/100

(57) ABSTRACT

A method for improving workflows for a print shop is disclosed. The method applies simulation, data mining, and qualitative reasoning to improve print shop workflows.

### TECHNICAL FIELD

The disclosed embodiments generally relate to automated approaches to improving workflows for a print shop. More particularly, the disclosed embodiments relate to the application of simulation, data mining, and qualitative reasoning to generate workflows with an increased probability of success.

### BACKGROUND

A print shop may be any workplace where printing is performed. In general, print shops produce large quantities of reproducible documents. Print shops have existed in various forms such the mid-1400's when the first printing press was invented. Modern print shops may use a wide variety of copy, control and other equipment to produce items such as books, maps, posters, newspapers, magazines, brochures and other publications.

Planning the execution of a job through a print shop may involve a combination of complicated individual processes. These may include activities such as job cost estimating, negotiating with customers, acquiring raw materials, testing materials for printability, production planning, creating proof copies, pre-pressing printing materials on various devices, binding the printing materials; pressing and finishing, delivering the finished product, and invoicing. Each print job, while following certain regularities in its developing and completion, rarely follows the same path, and each of the steps the overall workflow may fail in many different ways.

The technical field of Artificial Intelligence (AI) includes a sub-field known as computer-based planning. Computer-based planning studies the creation of plans, or specifications of a sequence of actions that will achieve a particular goal. One example of such a plan is a workflow. A workflow is a process that uses electronic systems to manage and monitor business processes, thus allowing the flow of work between individuals, devices and/or departments to be defined and tracked.

In a print shop, a workflow may include a large number of steps. For example, referring to FIG. 1, a relatively simple workflow of printing proof copy for a perfect bound book may consist of the following steps: accept delivery of the book text, illustrations, cover art and specification in electronic form (step 10); ensure that the text, illustrations and art are printable (step 12); check that the needed paper stock is on hand (step 14); check that the needed inks are on hand (step 16); load the correct stock into the machine that will print the black and white pages (step 18); load the correct stock into the machine that will print the color illustrations (step 20); load the correct stock into the machine that will print the cover (step 22); load the correct ink into the black and white machine (step 24); load the correct ink into the color machine that will print the illustrations (step 26); load the correct ink into the machine that will print the cover (step 28); print a single copy of the book on the three printers (step 30); collate the results (step 32); move the collated results to the binder (step 34); set the parameters on the binder (step 36); load the printed stock into the binder (step 38); bind the book (step 40); move the bound book to the trimmer (step 42); load the book into the trimmer (step 44); put the correct parameters into the printer (step 46); trim the book (step 48); and deliver the book to the approver to approval (step 50). The current techniques of computer based planning are too computationally complex to create plans of the length required for an application to print shop workflows.

Currently, most workflows in print shops are constructed and executed manually, where a sequence of steps is designated by a human, and the results of this designation are sent to other humans. The execution may be mediated by a workflow management system. However, the workflows and their failure modes are sufficiently complicated, particularly when devices break down and substantial redirection of the work is required in order to recover from the breakdown that aids the manual process of constructing workflows are desirable.

Without planning and improvement of existing workflows, print shop inefficiencies can result. Such inefficiencies can increase costs and produce waste. Some vendors have attempted to automate portions of the print shop work flow. Such vendors include Electronics for Imaging, Inc. and Creo Products Inc. However, such attempts do not yet provide opportunities to automate workflow analysis and improvement. Recently, a standard for an XML (eXtensible Markup Language) based language called Business Process Execution Language (BPEL) has been proposed. These systems allow execution of workflows. We know of no systems for automatically producing and improving workflows.

The present disclosure describes attempts to automatically improve workflows so they have an improved probability of success.

### SUMMARY

In accordance with an embodiment, a method of improving a print shop workflow may include identifying a print shop workflow, generating execution traces for a plan corresponding the workflow using discrete event simulation, analyzing the execution traces using data mining to extract patterns that are common in traces of workflow failures but uncommon in traces of workflow successes, and applying qualitative reasoning to the extracted patterns to determine an improvement to the plan. The execution traces may form a probabilistic model of the print shop, based on possible activities of at least one piece of equipment and workers in the print shop and possible outcomes from the activities. The model may be represented as a tree of process and resource nodes, and it may use data provided by manufacturers of equipment in the print shop, data created by documenting activities of the print shop, and/or other data. At least one of the workflows may be transformed into an electronic representation comprising a sequence of actions that correspond to process nodes in a job definition format tree. The model may use a representation of a set of possible print shop actions and a corresponding probability of one or more outcomes. The model may also use a set of qualitative rules that correspond to activities of the print shop in order to identify the improvement.

In accordance with another embodiment a method for improving workflows for a print shop includes: (i) simulation, wherein the simulation is performed more than one time by a discrete event simulator, and the simulation produces a database of good and bad plans; (ii) initial data mining, wherein the initial data mining extracts patterns of events that are common in workflow failures, but uncommon in workflow successes; (ii) subsequent data mining, wherein the subsequent data mining is performed on the extracted patterns from the initial data mining and produces a set of rules that demonstrate high frequency patterns in workflow failures; and (iv) qualitative reasoning. Pruning techniques may be applied to the extracted patterns after the subsequent data mining. In an embodiment, the qualitative reasoning may include the use of qualitative probabilistic networks, and it may produce suggested plan modifications, such as suggestions to add actions to or delete actions from the workflow.

In accordance with another embodiment, a print shop workflow improvement system includes a processing unit and a memory. The memory includes data representative of a print shop workflows. The processing unit receives instructions to simulate multiple plans in a print show workflow, wherein the plans comprise actions that may result in workflow success or workflow failure. The unit also mines the simulated plans to identify event patterns that correspond to workflow failures, analyzes the identified event patterns to produce rules that corresponding to action patterns for workflow failures, and identifies an improvement to at least one of the plans that will decrease a workflow failure probability for the plan. The simulation may include generating execution traces of print shop activities, based on possible activities of at least one of equipment and workers in the print shop and possible outcomes from the activities. The simulation may use data provided by manufacturers of print shop equipment, data created by documenting activities of the print shop, or other data. In an embodiment, at least one of the workflows may be transformed into an electronic representation comprising a sequence of actions that correspond to process nodes in a job definition format tree. The simulation may use a representation of a set of possible print shop actions and a corresponding probability of one or more outcomes.

### BRIEF DESCRIPTION OF THE DRAWINGS

FIG. 1 is a process diagram illustrating an exemplary print shop workflow.

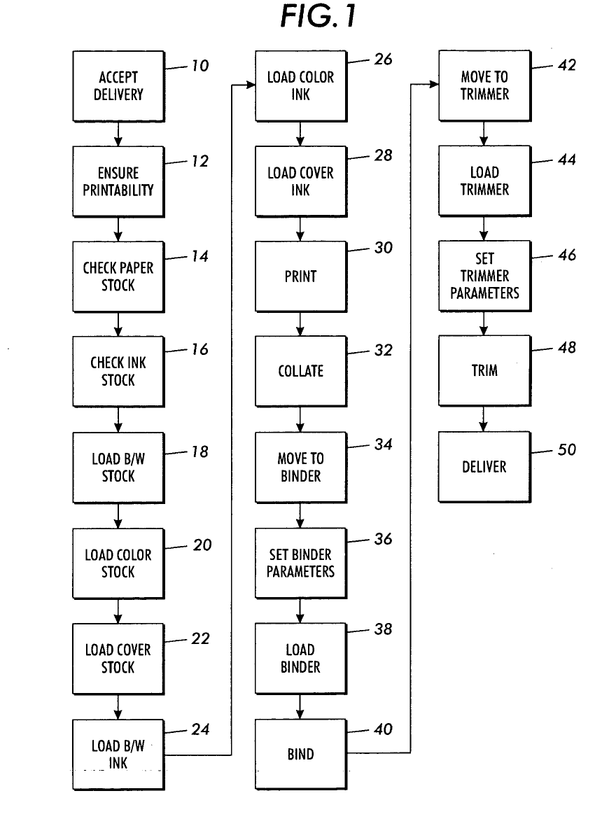

FIG. 2 depicts a flow diagram for an exemplary method of improving workflows for a print shop according to an embodiment.

FIG. 3 is a block diagram of exemplary hardware that may be used to contain and/or implement the program instructions of a system embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “document” is a reference to one or more documents and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described. All publications mentioned herein are incorporated by reference. Nothing herein is to be construed as an admission that the invention is not entitled to antedate such disclosure by virtue of prior invention.

The disclosed embodiments relate to methods for improving workflows for a print shop. An exemplary method uses a plan simulation process to evaluate and improve a workflow for a print shop.

A recent innovation in the field of computer based planning involves a technique, process and/or or algorithm, for improving large plans. One such technique, known as “IMPROVE,” involves simulation, data mining, qualitative reasoning, and planning. Rather than attempting to create new plans from first principles, this technique starts with one or more existing plans and uses a discrete event simulator to generate execution traces based on a probabilistic model of the domain. The plan is a representation of a sequence of abstract steps. For example, a “print” step may represent an infinite set of actual occurrences occurring at different times on different devices using different materials. Each simulation produces a potential trace of the plan, which is a representation of a specific set of actions that fits the description of the plan. In other words, the simulation is a trace of one of the ways this plan could be executed. A discrete event simulator allows the creation of such traces by choosing an outcome of some or all of the steps in the plan in accordance with the probability that such an outcome would occur if the action were really executed.

After the discrete event simulation is run several times, the traces are analyzed using data mining. This data mining looks for commonly occurring patterns within the traces. One example of a data mining procedure is described in PLANMINE: Predicting Plan Failures using Sequence Mining, Mohammed J. Zaki, Neal Lesh, and Mitsunori Ogihara, The University of Rochester, Technical Report 671, July 1998, where the PlanMine algorithm is described. The PlanMine algorithm is a sequence discovery algorithm for mining information from plan execution traces. The Zaki et al. paper notes how assessing plans in probabilistic domains is particularly difficult, and it demonstrates that analyzing execution traces is appropriate for planning domains that contain uncertainty. The traces may be mined for causes of plan failures, and the failures are supplied to a system that “reasons” about the failures in order to determine how best to modify the initial plan in order to increase the probability of success and improve future plans.

A third step of the IMPROVE process incorporates qualitative reasoning. Qualitative reasoning is an area of AI that creates representations for continuous aspects of the world, such as space, time, and quantity. Scientists, engineers and others may use qualitative reasoning when initially understanding a problem, when setting up more formal methods to solve particular problems, and when interpreting the results of quantitative simulations. Qualitative reasoning may be used to form a set of suggestions for changing the workflow plan in order to decrease the likelihood that the failures determined from the data mining will occur. One approach of qualitative reasoning is described as a qualitative probabilistic network (QPN). QPNs occupy a region in representation space where the objects are arbitrary variables, and the relationships are qualitative constraints on the joint probability distribution among them. See Fundamental Concepts of Qualitative Probabilistic Networks, Michael P. Wellman, Wright-Patterson AFB, Ohio 45433. As described in detail in the above-referenced paper, a qualitative network model is a graph-like structure with nodes representing variables and edges and hyper-edges that describe relationships among them. In a probabilistic model, the values of the variables as well as their interrelationships are uncertain, defined by a probability distribution over the joint value space.

For example, consider an exemplary, simplified workflow for printing a perfect bound book. This exemplary workflow consists of four steps: (1) print the book block; (2) print the cover; (3) bind the book block in the cover; and (4) trim the book block and cover. In this simplified situation, we may assume that the print shop has only one black and white printer on which the book block will be printed, one color printer on which the cover will be printed, one trimmer and one binder so that the exemplary plan is detailed enough to be executed without further choice. The discrete event simulator has a probability that the black and white printer will produce a book block, a probability that the color printer will produce a cover, a probability that the binder will bind the book and a probability that the trimmer will trim the book. With these probabilities, we can estimate the probability that the plan will execute successfully. Suppose the simulator runs the plan 100 times and it succeeds only 20 times. At this point we can say with great (e.g., approximately 99%) confidence that that plan has less than a 60% chance of success, as the simulation showed only a 20% chance of success. We know that the plan fails, but we do not know why the plan fails.

In an embodiment, print shop workflow steps may be represented in a computer-readable code using a format that is recognized by several devices in a print shop. One such format is known to those skilled in the art as Job Definition Format (JDF), although other formats may be used with the embodiments described herein. JDF is a file format that is currently defined by The International Cooperation for the Integration of Processes in Prepress, Press and Postpress Organization (known as “CIP4”). JDF is an industry standard designed to simplify information exchange between different applications and systems in and around the graphic arts industry. In its current version, JDF is a comprehensive XML-based file format and proposed industry standard for end-to-end job ticket specifications combined with a message description standard and message interchange protocol. One of the most prominent features of JDF is the ability to carry a print job from genesis through completion, including a detailed description of the creative, prepress, press, postpress and delivery processes.

JDF-formatted workflows include a tree of process and resource nodes. In JDF, every process has inputs and outputs. The output of one process in JDF becomes the input to the next process, so collectively inputs and outputs are called “resources.” The process nodes, therefore, represent a transformation to the resources, and the resources denote materials—both physical and electronic—required for the process node. A process includes an individual step in the production workflow. The process nodes also produce resources. JDF provides the framework for constructing such actions in concepts such as “machine,” “device,” “agent,” and “controller,” where an activity is defined according to a separate workflow language for each physical machine in the print shop. Thus, JDF can represent the state of the work at any moment in time, and the workflow language is used to specify how the process nodes should be mapped to particular devices.

In JDF, the resource nodes may be satisfied either by acquiring the resources (e.g., buying the paper and ink, or loading the electronic fonts), or by creating the resource through a process node. For each resource that needs to be acquired, the actions for acquiring the resources are defined. Typically, these actions are activities by humans that do not appear in JDF, such as ordering more paper or loading a tray with a particular type of paper. For those resources that can be produced by process nodes, a set of actions for accomplishing that node must be defined. Typically, these actions will be activities by the machinery in the print shop, such as printers, binders, raster image processors (RIPs), and other equipment.

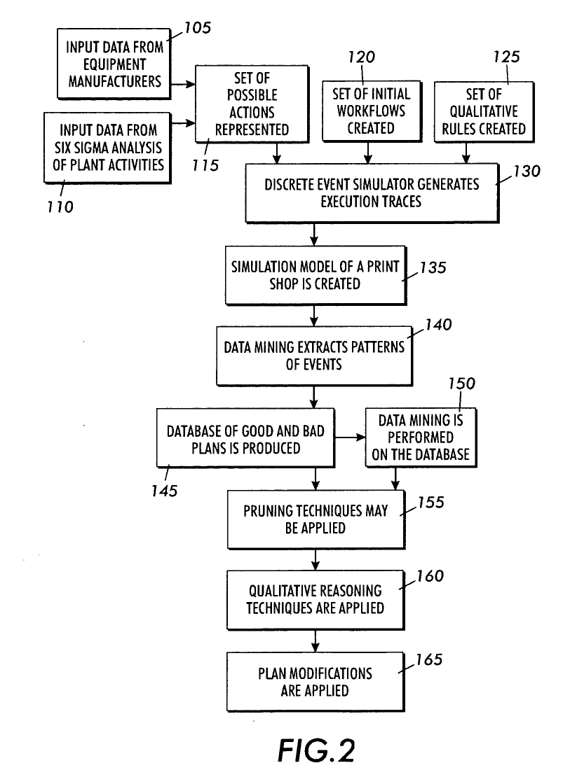

In an embodiment, print shop workflow simulation includes at least three elements: a discrete event simulator, a sequence mining algorithm, and a qualitative reasoning system, such as those that may be found in the IMPROVE process. FIG. 2 depicts a flow diagram for an embodiment. Initially, one or more workflows 120 are identified based on past, current or proposed activities of a print shop. These workflows may be transformed into an electronic representation, such as a computer file, that records a sequence of actions in a print shop. An action may be a set of consequences that is associated with a set of outcomes. For example, an action may be a set of consequences {(t₁, e₁, p₁), . . . (tₙ, eₙ, pₙ)}, where for every i, tᵢ is an expression referred to as the consequence's trigger, eᵢ is a set of literals referred to as the consequence's effects, and pᵢ is a numeric representation of the probability that the action will have the effect eᵢ if executed in a state in which tᵢ holds. In an embodiment, the actions may correspond to process nodes in a JDF tree, although other formats are possible.

Thus, the workflow may include a set of possible triggers, and probability-based effects based on those triggers, for activities in the print shop. The triggers may be activities performed by humans, such as ordering more paper or loading a tray with a particular type of paper, or they may be activities performed by machinery in the print shop (e.g., printers, binders, and RIPs). Each action has a probability of a set of outcomes associated with it.

Continuing with the print shop workflow example above, and simplifying even further, we would have a number of tuples describing the potential outcomes of each of the possible actions. For example, we may represent the action of printing on the black and white printer with the set {(Ink, Paper), BookBlock, 90>, <(Ink, Paper), Other, 10> <(NoInk), Other 100> <(NoPaper), Other, 100)}. In this example, the first element in the tuple is the trigger, i.e., the circumstances under which the action was taken. So, here, (Ink, Paper) indicates that ink and paper were available to print the book block at a point in time. The result is the second element in the tuple, e.g. BookBlock, and represents the changes to the state of the world after the action has been taken. The third element is the probability that the result will obtain after the action has been taken. Here, if ink and paper are available, the printer can produce a book block 90% of the time, if either ink or paper is missing, the printer never produces a book block.

For example, the probability of a particular outcome given a particular action denotes the number of times the outcome holds after that action has been undertaken. Each successful completion of an action may transform the JDF tree by removing the process node it corresponds to and replacing it with the resources generated by the successful outcome.

As an example of an action set for a workflow, consider a workflow that includes the action of requesting a job to print fifty color pages on a particular printer. In one variant, success may be considered to be the expected outcome of the action, resulting in the printing of the fifty color pages. Failure may be considered any other outcome. Alternatively, success may be defined in more complex terms, where success is the printing of fifty color pages in all desired colors, partial success is the printing of more than twenty-five but less than fifty color pages in all desired colors, failure is the correct printing of less than twenty-five color pages, and the printing of less than twenty-five color pages is considered to be a breakdown or some level below failure.

The probability of the outcomes for each of the actions may be produced by choosing probabilities based on human input (i.e., subjective probability), through actual data resulting from trials and/or manufacturer's data (i.e., objective probability), or a combination of those and similar methods. If subjective probability is chosen, the probabilities may be updated with experience, for example using the well known Bayes' rule: Pr(A|B)=Pr(B|A)Pr(A)/Pr(B).

A goal may be selected, and an overall probability of a workflow achieving a goal may be determined. In an embodiment, a discrete event simulator may simulate a workflow 130, starting with the workflow's initial state. It may then “roll the dice” to determine the action's consequences. Thus several execution traces are generated, which together form a tree that grows from the initial state. Each branch of the tree is built by defining process actions along with their possible outcomes and probabilities of the outcome 130. The number of possible outcomes may be controlled by limiting the level of description of the outcomes. The simulator may use a set of qualitative rules 125, indicating a change in probability of other states given the change in one state caused by an action. Data for this simulation may come from numerous places, such as manufacturers of the equipment 105 or from a Six Sigma or other analysis of shop activities 110, test data, or other inputs. Such data may be input directly into the simulator, or it may be part of an action set 115 or workflow 120.

The discrete event simulator uses the action representation as a probabilistic model of the print shop 135. The simulation model may include possible activities of at least some of the equipment and workers in the print shop, and possible outcomes from each of these, including a probability of each outcome. Thus, the discreet event simulator is used to generate execution traces based on a probabilistic model of the domain 130. Each simulation produces a potential trace of the plan. For example if we are trying to produce a book block and have probabilities similar to the ones set out for the black and white printer for the color printer, the binder and the trimmer, we might achieve the following set of traces. Here we assume that ink and paper are available. If we ran the simulation four times, we might see the following results: {(BookBlock, Cover, Bound, Trimmed), (Other, Cover, Other, Other), (BookBlock, Cover, Bound, Trimmed), (BookBlock, Cover, Bound, Trimmed)} In the first, third and fourth traces, the book was successfully-created. In the second case, the black and white printer failed causing failures in the binding and trimming.

In an embodiment, data mining may be performed on the execution traces in order to extract patterns of events that are common in traces of plan failures, but uncommon in traces of plan successes 140. The data mining may be done by any method of mining sequence patterns known to those skilled in the art. For example, the PlanMine algorithm (described above), the SPADE algorithm (described by Zaki, “Fast Mining of Sequential Patterns in Very Large Databases,” Technical Report URCS TR 668, University of Rochester (1997)), sequential discovery (described by Argagwal & Srikant, “Mining Sequential Patterns, (Int'l Conf. on Data Eng'g (1995)), and other methods may be used to pinpoint defects in the plan that are more likely to lead to plan failure. After simulation of a plan is performed multiple times, a database of “good” and “bad” plans may be produced 145. The number of traces required depends on the complexity of the simulation model. Standard statistics indicate how to calculate the probability of arriving at an incurred conclusion based on the number of degrees of freedom in the model. Here, the model is complex, so the number of traces needed is large, typically in the thousands. It is generally possible to create enough traces because discrete event simulators run efficiently. A distinction between a “good” plan and a bad plan may be generated based on any number of factors, such as the overall probability of the plan achieving a goal. Optionally, data mining may also be performed on this information, which discovers high frequency patterns in bad plans 150.

Optionally, pruning techniques may be applied in order to generate a final set of rules that are highly predictive of plan failure 155. Pruning techniques may include, for example, pruning normative patterns, where those patterns that not only occur in bad plans, but also occur in good plans quite often, are eliminated; pruning redundant patterns, where all redundant patterns that have the same frequency as at least one of their proper subsequences, are eliminated; and pruning dominated patterns, where all dominated sequences that are less predictive than all of their proper subsequences are eliminated. Data mining may be performed multiple times until a desired stop point is reached. A stop point may be, for example, a point where no further improvements are obtained or until the probability of success stops increasing. The patterns discovered by the plan mining are used to determine what to fix within the plan.

In an embodiment, qualitative reasoning techniques may be used to modify the plan to reduce or avoid the problems, or failures, that were identified in the simulation and data mining 160. This technique identifies an action or actions that may increase the probability of reaching a goal, such as success of the workflow. One possible qualitative reasoning technique that may be used a qualitative probabilistic network, such as that described by Lesh, Martin and Allen in “Improving Big Plans,” Proceedings of the Fourteenth National Conference on Artificial Intelligence (1996). However, any way of applying probabilistic knowledge may be used.

The plan modifications that are determined from the qualitative reasoning techniques may necessitate further planning, such as adding actions to, or omitting actions from, a plan 165. Thus, the plan may require further modifications to accommodate new changes.

The plan modifications may be represented as a set of rules that can improve work shop print flows. For example, suppose the print shop is interested in improving the plan to print paperback books. It evaluates the activities five times and discovers that it fails once out of the five. Though this may be a small number in practice, it suffices for the example. Estimating the probability we arrive at 80%. This may be deemed to be inadequate and the shop may decide to improve the workflow. The traces are mined to capture the one that failed. (In this example, of course, one can see at a glance that one of the five traces resulted in failure.) The qualitative reasoner may be invoked and it returns the suggestion that an additional action—loadPaper—be added to the beginning of the workflow. This new workflow is simulated and there are no further failures. Note that this is not necessarily the case, further failures are possible. Indeed with the small sample collected here, the results of the improved workflow could appear to be worse, depending on the factors involved.

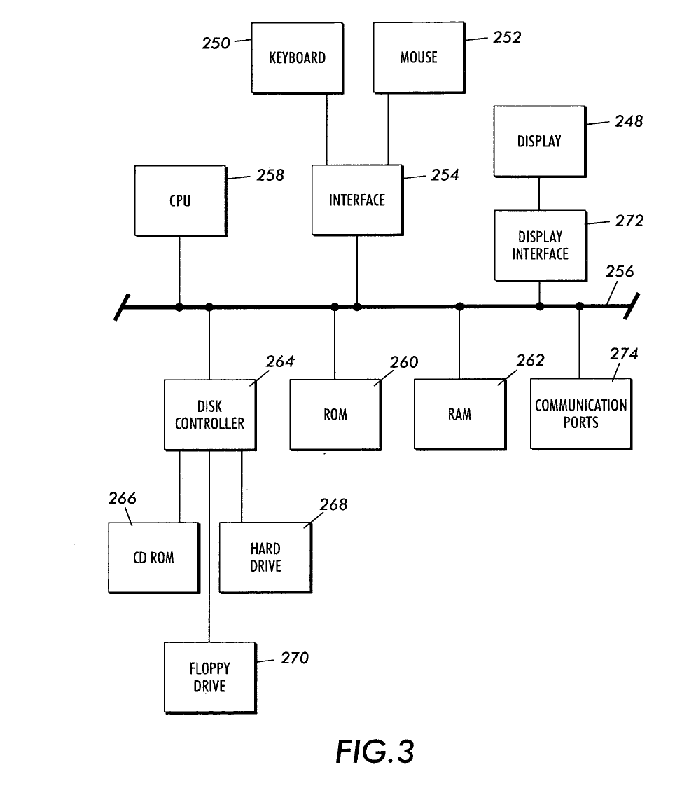

FIG. 3 is a block diagram of exemplary hardware that may be used to contain and/or implement the program instructions of a system embodiment. Referring to FIG. 2, a bus 328 serves as the main information highway interconnecting the other illustrated components of the hardware. CPU 302 is a central processing unit of the system, performing-calculations and logic operations required to execute a program. Read only memory (ROM) 318 and random access memory (RAM) 320 constitute exemplary memory devices.

A disk controller 304 may interface with one or more optional disk drives to the system bus 328. These disk drives may be external or internal memory keys, zip drives, flash memory devices, floppy disk drives or other memory media such as 310, CD ROM drives 306, or external or internal hard drives 308. As indicated previously, these various disk drives and disk controllers are optional devices.

Program instructions may be stored in the ROM 318 and/or the RAM 320. Optionally, program instructions may be stored on a computer readable medium such as a floppy disk or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports 326. An exemplary communication port 326 may be attached to a communications network, such as the Internet or an intranet.

In addition to the standard computer-type components, the hardware may also include an interface 312 which allows for receipt of data from input devices such as a keyboard 314 or other input device 316 such as a remote control, pointer and/or joystick. A display including touch-screen capability may also be an input device 316. An exemplary touch-screen display is disclosed in U.S. Pat. No. 4,821,029 to Logan et al., which is incorporated herein by reference in its entirety.

An embedded system may optionally be used to perform one, some or all of the operations of the methods described. Likewise, a multiprocessor system may optionally be used to perform one, some or all of the methods described.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for improving a print shop workflow, the method comprising:
identifying a print shop workflow;
generating execution traces for a plan corresponding to the workflow using discrete event simulation;
analyzing the execution traces using data mining to extract patterns that are common in traces of workflow failures but uncommon in traces of workflow successes;
applying qualitative reasoning to the extracted patterns to determine an improvement to the plan.

2. The method of claim 1, wherein the execution traces form a probabilistic model of the print shop, based on possible activities of at least one of equipment and workers in the print shop and possible outcomes from the activities.

3. The method of claim 2, wherein the model comprises a tree of process and resource nodes.

4. The method of claim 2, wherein the model uses data provided by manufacturers of equipment in the print shop.

5. The method of claim 2, wherein the model uses data created by documenting activities of the print shop.

6. The method of claim 5, wherein at least one of the workflows is transformed into an electronic representation comprising a sequence of actions that correspond to process nodes in a job definition format tree.

7. The method of claim 2, wherein the model uses a representation of a set of possible print shop actions and a corresponding probability of one or more outcomes.

8. The method of claim 1, wherein the model uses a set of qualitative rules, where the qualitative rules correspond to activities of the print shop.

9. A method for improving workflows for a print shop, the method comprising:
simulation, wherein the simulation is performed more than one time by a discrete event simulator, and the simulation produces a database of good and bad plans;
initial data mining, wherein the initial data mining extracts patterns of events that are common in workflow failures, but uncommon in workflow successes;
subsequent data mining, wherein the subsequent data mining is performed on the extracted patterns from the initial data mining and produces a set of rules that demonstrate high frequency patterns in workflow failures;
qualitative reasoning.

10. The method of claim 9, wherein pruning techniques are applied to the extracted patterns after the final data mining.

11. The method of claim 9, wherein the qualitative reasoning comprises the use of qualitative probabilistic networks.

12. The method of claim 9, wherein plan modifications are determined from the qualitative reasoning.

13. The method of claim 12, wherein the plan modifications comprise adding actions to the workflow.

14. The method of claim 12, wherein the plan modifications comprise removing actions from the work flow.

15. A print shop workflow improvement system, comprising:
a processing unit; and
a memory;
wherein the memory includes data representative of a print shop workflows, and the processing unit receives instructions to:
simulate a plurality of plans in a print show workflow, wherein the plans comprise actions that may result in workflow success or workflow failure;
mining the simulated plans to identify event patterns that correspond to workflow failures;
analyzing the identified event patterns to produce rules that corresponding to action patterns for workflow failures; and
identifying an improvement to at least one of the plans that will decrease a workflow failure probability for the plan.

16. The system of claim 15, wherein the simulation comprises generating execution traces of print shop activities, based on possible activities of at least one of equipment and workers in the print shop and possible outcomes from the activities.

17. The system of claim 15, wherein the simulation uses data provided by manufacturers of print shop equipment.

18. The system of claim 15, wherein the simulation uses data created by documenting activities of the print shop.

19. The system of claim 15, wherein at least one of the workflows is transformed into an electronic representation comprising a sequence of actions that correspond to process nodes in a job definition format tree.

20. The system of claim 15, wherein the simulation uses a representation of a set of possible print shop actions and a corresponding probability of one or more outcomes.
